(19) United States
(12) Patent Application Publication
(10) Pub. No.: US 2014/0191010 A1
(43) Pub. Date: Jul. 10, 2014

(54) Multi-Capacity Stapler

(71) Applicant: Matthew Sean Tucker, Fort Lauderdale, FL (US)

(72) Inventor: Matthew Sean Tucker, Fort Lauderdale, FL (US)

(21) Appl. No.: 13/734,131

(22) Filed: Jan. 4, 2013

(51) Int. Cl. B25C 5/16; B25C 5/11

(52) U.S. Cl. CPC B25C 5/1658; B25C 5/11; B25C 5/1665
USPC 227/109; 227/129; 227/140

(57) ABSTRACT

A stapler comprising a base, a cartridge in pivotal relation to the base at a cartridge pivot axis, the cartridge configured to contain at least two rows of staples and a lever arm in pivotal relation to the base at a lever pivot axis. In an embodiment, the device includes a moveable driving member for selectively positioning the driving member in driving relation to each of the at least two rows for driving staples from the at least two rows. In operation, this invention permits an individual to load a stapler with multiple sized staples. This eliminates the need to continuously load and unload different sized staples from a single row stapler.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a multi-capacity stapler and in particular to a multi-capacity stapler operable to hold two sized staples.

### BACKGROUND OF THE INVENTION

Staplers commonly include a base and an assemblage in pivoting relation to the base for driving a staple into a stack of paper for joining that stack of paper together. The assemblage includes a cartridge that houses a row of staples. Staplers commonly include a lever arm in conjunction with the assemblage for applying sufficient force to puncture a stack of paper on a front side and cause the staple to fold across the back side of the paper stack. The assemblage also commonly includes a driver for driving the staple into and through the stack of paper.

Heavy duty staplers are capable of accepting various size staples. For example, staple sizes include, without limitation, ¼ inch (6 mm) for stapling approximately 2-30 sheets of paper; ⅜ inch (10 mm) for stapling approximately 25-60 sheets of paper; ½ inch (13 mm) for stapling approximately 40-100 sheets of paper; and ⅝ inch (16 mm) for stapling approximately 70-115 sheets of paper. However, these staplers can only hold one row of staples which are filled with one size of staple at a time.

The prior art only allows for loading and delivering staples from a single row. Resultantly, a shortcoming of the prior art exists when the stapler is loaded with a particular size staple that is either too large or too small for a particular stack of paper. In an office setting, it is common for professionals to staple paper stacks all day long. For many professionals, the paper stacks are rarely the same size. For example, a professional might have to first staple a stack of thirty sheets that requires a ⅜ inch staple and next staple a stack of one hundred ten sheets requiring a ⅝ inch staple. Thus, the professional must first insert the ⅜ inch staples into the cartridge to staple the thirty sheets. Next, the professional must remove the ⅜ inch staples and insert the ⅝ inch staple to staple the one hundred ten sheets. Having to check which staples are loaded in the stapler is additionally burdensome. Even more burdensome—and far more common—the professional forgets to check the size of the staple in the stapler. This results in the professional using the wrong size staple. In the event that the staple is too small, the staple does not wrap around the back of the stack of paper. Even worse, the ends of the wrong sized staple may stick straight out of the stack of paper. Professionals can prick their fingers on the dangerous staple tips. Alternatively, the professional may use a staple that is too large, in which case, the stapler may jam. Some offices will keep multiple heavy duty staplers to band-aid this shortcoming. However, the multiple staplers do commonly are not labeled, thus, the professional must guess which stapler is loaded with which stapler.

Furthermore, continuously swapping the row of staples in the assemblage is additionally burdensome. It is particularly burdensome when multiple stacks of paper are printed and each of those stacks contain a different number of pages requiring continuously unloading and loading the stapler with different sized staples.

An additional shortcoming includes the number of staples that a stapler holds because the prior art is limited to a single row of staples.

Accordingly, there is a need in the art for a device that includes a cartridge capable of maintaining multiple rows of staples. Additionally, there is a need for a device that is configured to select between multiple size staples and/or rows of staples.

### SUMMARY OF THE INVENTION

The present invention advantageously provides a device, system and method for maintaining and delivery of multi-sized staples.

According to one embodiment, a stapler is provided. The stapler includes a base. A cartridge in pivotal relation to the base at a cartridge pivot axis. The cartridge configured to contain at least two rows for maintaining staples. A lever arm is in pivotal relation to the base at a lever pivot axis.

According to another embodiment, a device is provided. The device includes a base. A cartridge in pivotal relation to the base at least at a cartridge pivot axis. The cartridge capable of simultaneously containing a first row of a first size of staples and a second row of a second size of staples. A lever arm in pivotal relation to the base at least at a lever pivot axis.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of the multi-capacity stapler configured to deliver staples from at least two rows of staples in accordance with the principles of the present invention;

FIG. 2 is a perspective view of the multi-capacity stapler configured to deliver staples from at least two rows of staples in accordance with the principles of the present invention;

FIG. 3 is side view of the multi-capacity stapler of FIG. 1 in a first position;

FIG. 4 is a side view of the multi-capacity stapler of FIG. 1 in a second position;

FIG. 5 is a side view of the multi-capacity stapler of FIG. 1 in a third position;

FIG. 6 is a perspective view of the multi-capacity stapler configured to deliver staples from a slidable cartridge in a first position in accordance with the principles of the present invention;

FIG. 7 is a perspective view of the multi-capacity stapler configured to deliver staples from a slidable cartridge in a second position in accordance with the principles of the present invention;

FIG. 8 is a side view of the multi-capacity stapler employing a jam clearing mechanism in accordance with the principles of the present invention; and

FIG. 9 is a cross sectional view of FIG. 1 depicting the slidable driving member in accordance with the principles of the present invention.

### DETAILED DESCRIPTION OF THE INVENTION

The present invention advantageously provides—in a first embodiment—a system and method for a multi-capacity stapler configured to maintain and deliver at least two sized staples. The invention further discloses—in an alternative embodiment—a system and method for a multi-capacity stapler configured to maintain and deliver staples from at least two rows of staples, without regard to the staple size.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

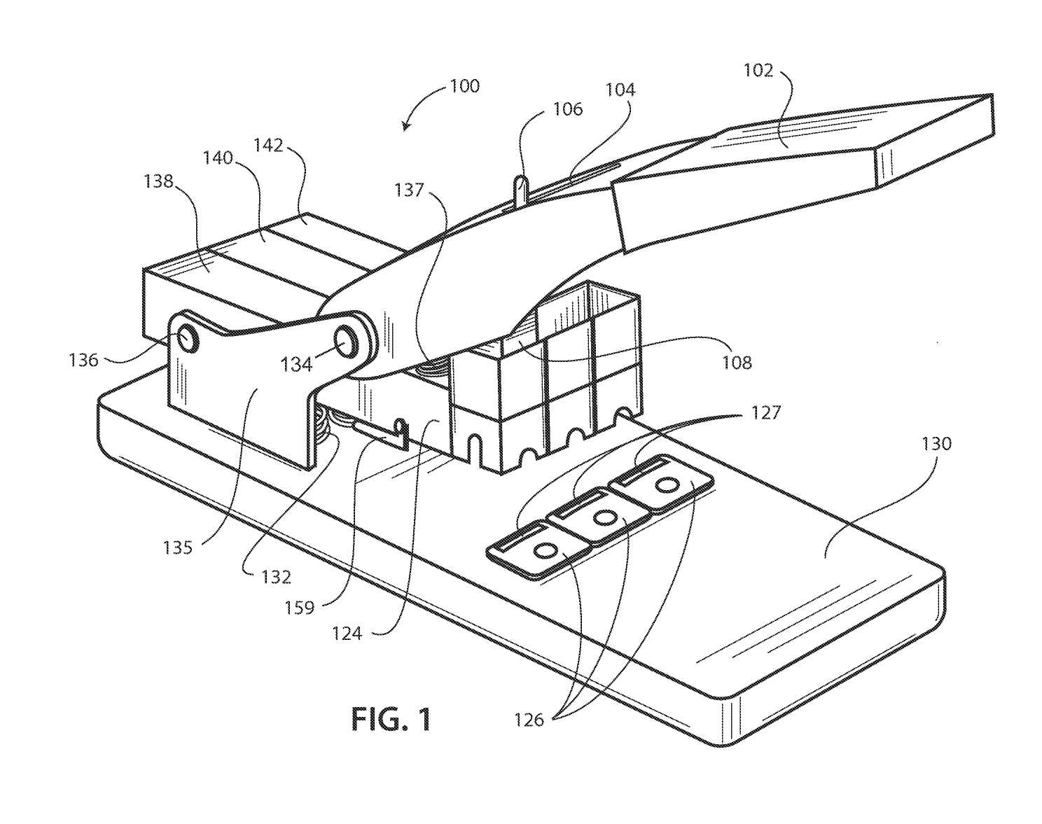

Referring now to the drawings figures in which like reference designators refer to like elements there is shown in FIG. 1 an exemplary stapler constructed in accordance with the principles of the present invention and designated generally as “100.” In particular, stapler 100 is a heavy duty stapler capable of delivering any sized staple in accordance with the principles of the present invention. Though stapler 100 is depicted as a heavy duty stapler, it is contemplated that any sized stapler—or any type of stapler—that is operable to and/or configured to maintain and deliver at least two sized staples is within the scope of the present invention. Additionally, any stapler capable of holding at least two sized staples simultaneously for selectively delivering between the at least two sized staples is within the scope of the present invention. The stapler may or may not include a base member, as further disclosed herein or otherwise known in the art. Though the purpose of the invention is to load the stapler with two sized staples, it is contemplated that the invention is equally capable of receiving at least two rows of the same size staples for providing a stapler capable of holding more staples than a typical stapler.

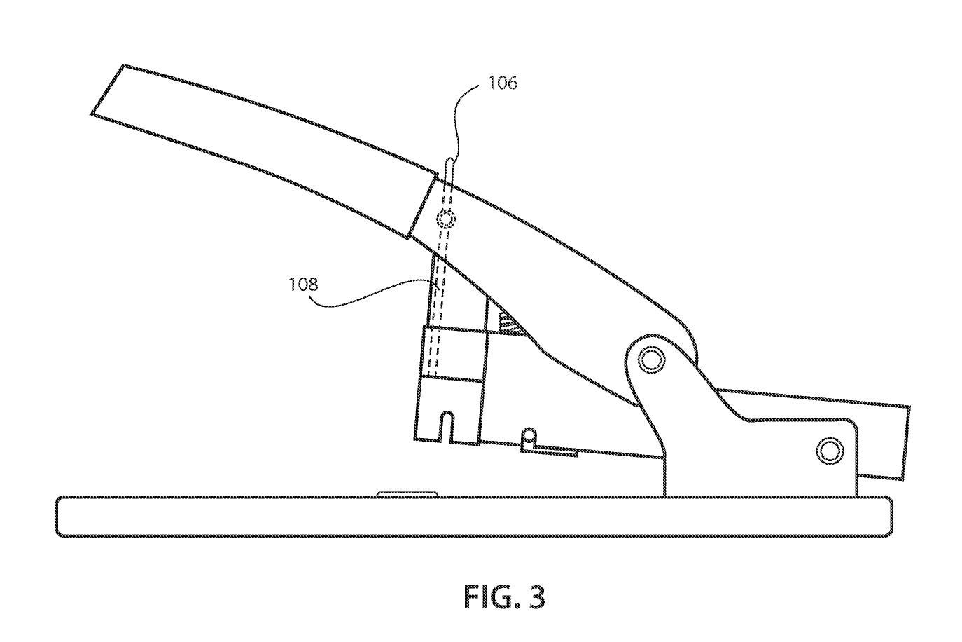

FIG. 1 discloses a heavy duty stapler 100. The stapler includes a lever 102. The lever is configured for receiving a force by a user. The lever causes a staple to be driven into a selected material. Materials are defined as any material capable of receiving a staple, including without limitation, a stack of paper, wood, and human skin. The lever is secured on two sides in a pivoting relation about a first axis 134 to the stapler cartridges 124 and/or a bracket 135. Further the bracket 135 is secured to the base 130. The bracket 135 may be defined as a portion of the base. The lever is further coupled in pivoting relation about a second axis 136 to the base 130. The cartridge(s) 124 are additionally coupled in pivoting relation about the second axis 136. Although the lever is depicted such that the lever is indirectly coupled to the base, it is contemplated that the lever may be coupled directly or indirectly to the base. Further is it contemplated that the cartridge and lever may be configured in any known stapler configuration. Springs 132 exerts a force on the cartridges 124 and the lever 102. The springs 132 are configured to maintain the cartridges 124 in a first ready position depicted in FIGS. 1-3. Further, springs 132 cause the cartridges 124 to return to the first ready position after the downward force received on the lever 102 is removed. Lever springs 137 cause the lever 102 to return to the first ready position, depicted in FIG. 1, after the down force received on the lever 102 is removed. A users force and the springs cause the cartridge and the lever to oscillate as depicted by the first position, second and third position in FIGS. 3-5. The oscillation may comprise the up and down movement of cartridge and lever in relation to the base.

In an embodiment, the cartridge is defined as the body that maintains and/or holds at least one row of staples. Commonly the staples are held within the body of the cartridge, however, it is not necessary that the staples are enclosed within the cartridge.

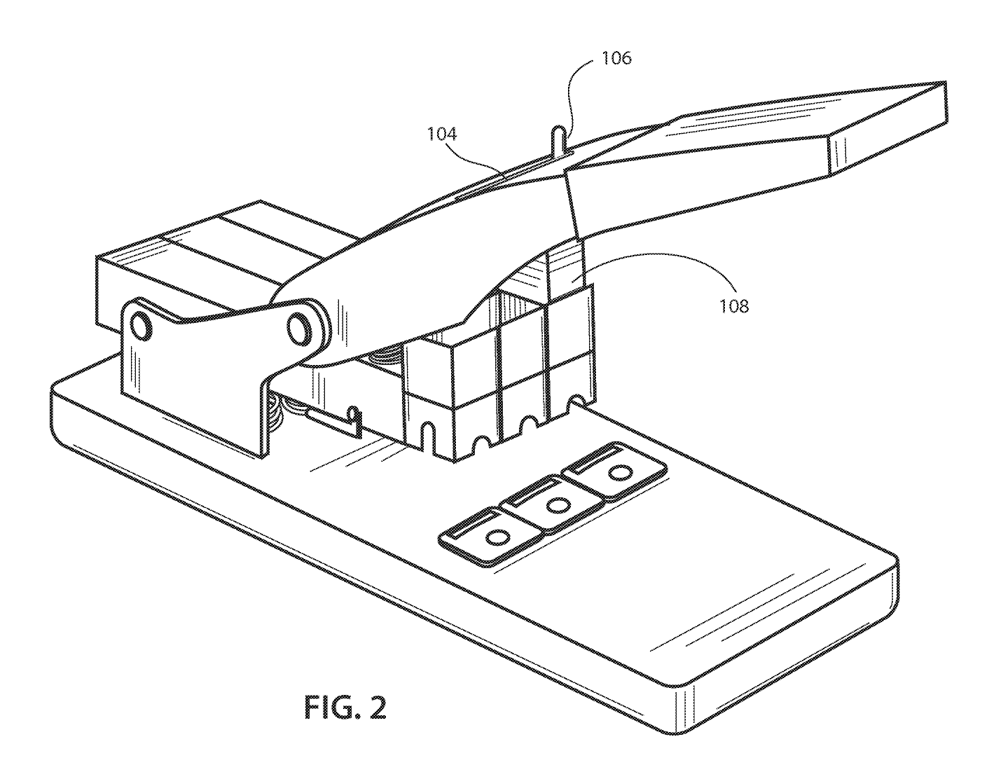

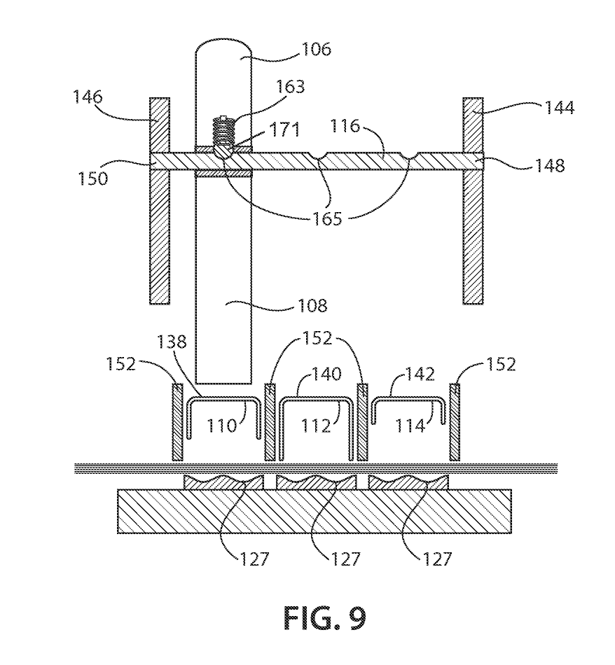

The lever, further depicted in FIGS. 1-2, includes an aperture 104. The aperture permits a slidable member 106 to move about the aperture. The aperture may be as large as necessary to permit operation of the lever. The slidable member 106 is configured to move a driving member 108 from a first position to at least a second position. In an exemplary embodiment, the slidable member 106 is configured to move laterally. For example, FIG. 1 depicts slidable member 106 in a first position, whereas FIG. 2 depicts slidable member 106 in a third position. In operation, the first position causes during stapler operation—driving member 108 to drive a staple from a first row 138 of staples (staples hidden by cartridge). The second position (not shown) causes—during stapler operation—driving member 108 to drive a staple from a second row 140 (middle row) of staples (staples hidden by cartridge). The third position causes—during stapler operation—driving member 108 to drive a staple from a third row 142 of staples (staples hidden by cartridge). There can be an infinite number of rows without departing from the spirit and/or scope of the instant invention. An important aspect of the instant embodiment includes at least two rows of staples. Preferably, the two rows comprise at least two sized staples. However, it is contemplated that the two rows of staples may be the same size staples. As shown in the cross-sectional view of FIG. 9, the stapler includes three rows of different sized staples 110, 112 and 114.

Alternatively, the spirit of the present invention contemplates the stapler receiving two sized staples, in any number of rows or columns, for selectively driving at least two size staples. In this alternative, the staples may be loaded into one single row. The stapler may selectively drive staples on each side of the one row, thus permitting one row of at least two sized staples that may be selectively driven into paper, wood, or any other material that accepts staples.

Material capable of receiving staples may additionally include any material capable of accepting staples without departing from the spirit and scope of the instant invention, including without limitation, paper, wood, human skin, and etc.

Further depicted in FIG. 9 is a cross section view of the stapler for depicting how the driving member is moved over the at least two rows of staples. The moveable member 106 and driving member 108 slides laterally for positioning above at least one staple in a particular row of staples. There should be sufficient space between the distal end of driving member 108 and cartridge sidewalls 152 to allow the driving to slide freely, unobstructed and without contacting the sidewalls when the lever is in the first position, the first position depicted by FIG. 3. The moveable member may snap into place above any of each row of staples 110, 112 and 114 so that—during stapler operation—the driving member 108 does not contact any of the top of any of the plurality of sidewalls 122 of the stapler cartridges 124. The moveable member 106 may include a friction locking mechanism for holding the moveable member 106 and driving member 108 in place. The Moveable member 106 and/or driving member 108 may lock into place so that user manipulation and/or other electronic control is required to unlock and move moveable member 106 and/or driving member 108. For example, FIG. 9 depicts an exemplary friction locking mechanism. This embodiment includes a bearing 171 and spring 163 within the moveable member 106. The spring provides a downward force for maintaining the bearing 171 within an aperture 165. This allows the user to feel when the driving member 108 is properly positioned to drive a particular row of staples. In FIG. 9, the bearing causes the driving member to be maintained over the first row of staples 138. When the user, or mechanically actuated movement, slides the moveable member 106 and driving member 108 to the second row of staples 140, the bearing will rest within aperture 165 for causing the proper alignment of the second row 140.

FIG. 9 additionally depicts three rows of staples 142, each of the staples being three different sizes. Cartridge sidewalls 152 are depicted for containing the staples 142. FIG. 9 further depicts stack of paper 128 positioned for accepting a staple.

In an embodiment, the moveable member slides laterally along bar 116. Bar 116 include two ends 148 and 150. The bar is secured at each end 148 and 150 to lever 102 sidewalls 144 and 146. Alternatively, the bar 116 may be directly or indirectly coupled to the lever 102. The moveable member 106 is configured to move laterally in relation to bar 116 and lever 102. Moveable member 106 and driver member 108 may or may not move in direct relation to lever 102 without departing from the spirit and/or the scope of the present invention.

FIG. 2 is a perspective view of the multi-capacity stapler configured to deliver staples from at least two rows of staples. The slidable member 106 is in a third position for delivering staples from an alternative row of staples. FIG. 2 particularly depicts the driver member 108 configured to deliver staples from a third row 142 of the cartridge that maintains a row of staples.

FIGS. 1 and 2 depict three staple plates 126. Each staple plate is attached to a stapler base 130. Each stapler plate 126 receives a staple being driven by driving member 108. Each stapler plate 126 is shaped at staple shaping aperture 127 to cause distortion and/or shaping of a staple. In a particular operation, each stapler plate 126 causes a driven/received staple to curl into a position against—or otherwise contact—a bottom 138 of a stack of paper 128.

In an embodiment, the cartridge may be configured as a single cartridge configured to hold at least two rows of staples. Commonly, staplers include cartridges that slide open to permit replacement of the staples. Alternatively, staplers otherwise open to permit staples to be loaded into the cartridge. In either case, according to this invention, the cartridge is configured to allow replacement of at least two rows of staples at the same time. Thus, the cartridge may be configured to allow replacement of all of the rows of staples at the same time. Thus, accessing one row of the cartridge permits a user to access at least a second row of the cartridge for refilling or replacing the staples of that second or more rows. For further example, a tray may slide open that includes at least two rows of staples wherein the at least two rows are situated parallel to one another. In this embodiment, the cartridge opens to allow replacement of at least two rows of staples.

Alternatively, the cartridge may be configured to permit individual replacement of a row of staples. In this alternative embodiment, at least one row of the cartridge remains inaccessible during replacement of another row of the cartridge with a row of staples. Wherein a row of a cartridge is defined as a row configured to contain a row of staples. Although it is contemplated that the cartridge in this alternative permits individual access to the row of the cartridge for replacing a single row of staples, it is contemplated that those rows could still selectively be replaced at the same time by the user individually opening or interacting with the individual rows of the cartridge for refilling the rows at the same time. However, in this alternative, the user is not forced to access more than one row at the same time. For example, the cartridge may include two trays, wherein each tray slides open without relation to the other tray. Further contemplated is that the cartridge includes at least two bays that may be accessed individually for individually and separately loading each row of staples.

In an embodiment, multiple cartridges may be configured to each hold at least one row of staples. In this embodiment, each cartridge opens individually to permit replacement of the at least one row of staples for each cartridge. Alternatively, each cartridge may open in unison to permit replacement of rows of staples.

FIG. 3 depicts a multi-capacity stapler in a first position. The lever 102 in the starting position is configured to allow a hand to encompass the lever for applying downward pressure for driving a staple into a stack of paper.

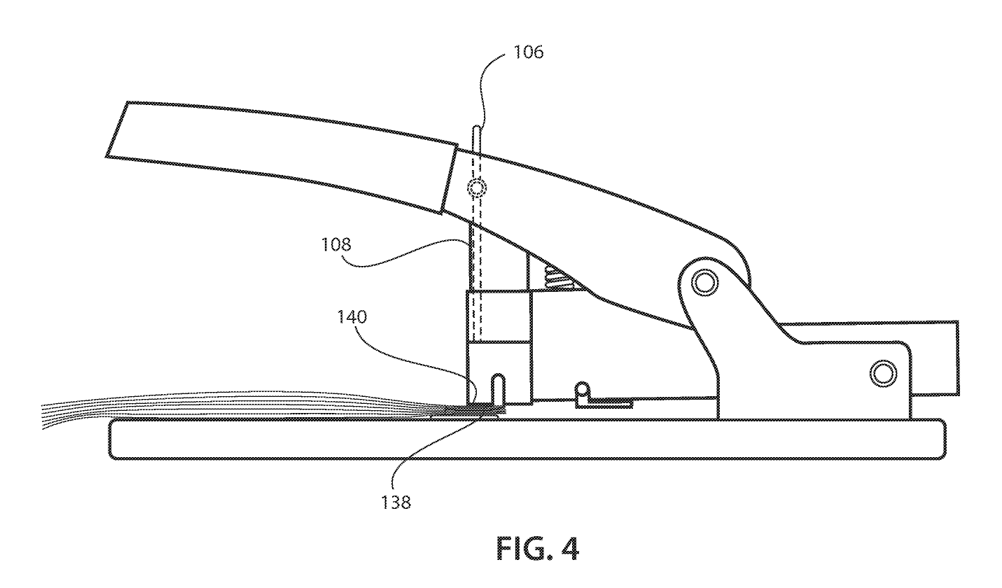

FIG. 4 depicts a multi-capacity stapler in a second position. In operation, the lever 102 is in a second position. In the second position, the cartridges 124 move downward against the top 140 of a stack of paper 128. The cartridge pivots bout the axis and/or moves downward in relation to the base 130.

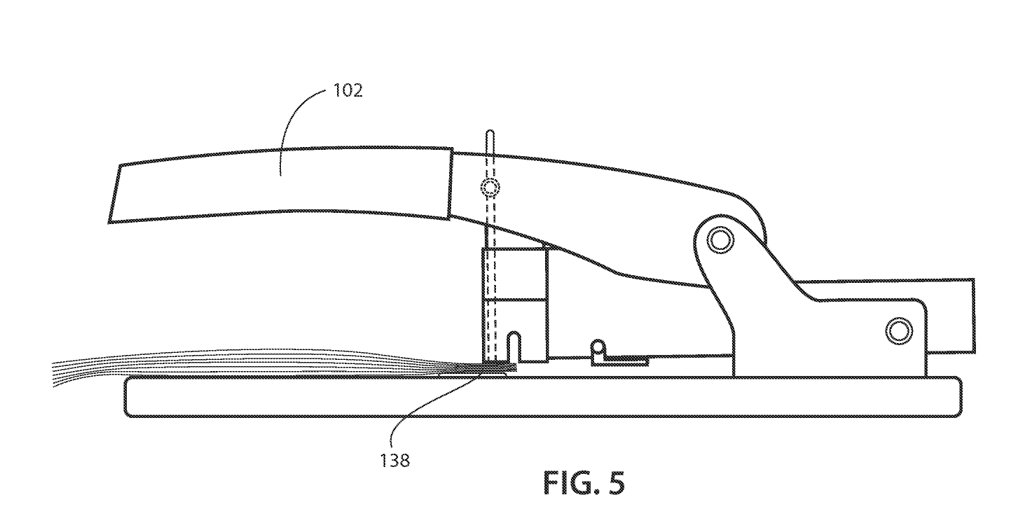

FIG. 5 depicts a multi-capacity stapler in a third position. In operation, the lever 102 is a third position wherein the lever 102 and the cartridge 124 has moved downward in relation to the base 130 for driving a staple. In the third position shows the lever 102 having caused the driver member 108 to drive a staple into and through a stack of paper 128. Further, pressure from the driving member 108 causes the staple to curl around the back 138 of the stack of paper 128.

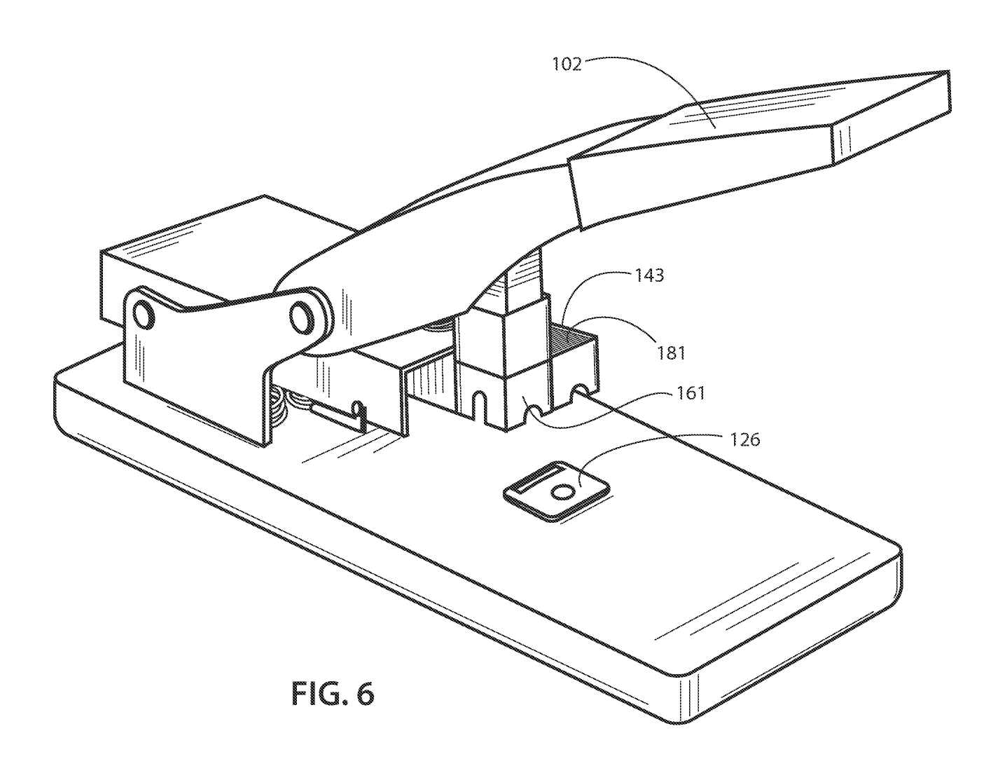

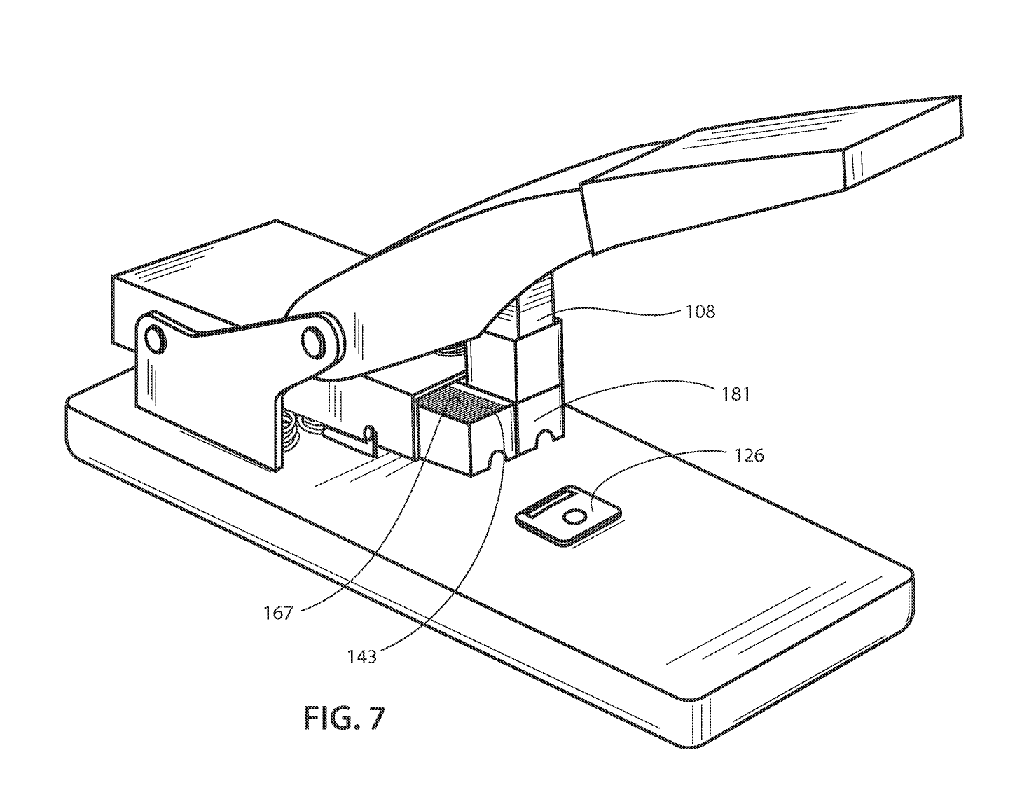

FIGS. 6 and 7 show an alternative embodiment where the stapler having a cartridge or cartridges are configured to slide laterally for selectively placing a staple from at least row of staples below a driving member 108. In this configuration, the driving member 108 does not move laterally. Instead, the cartridge will move laterally to position a staple from at least two rows of staples in a position to be driven into a stack of paper 130. FIGS. 6 and 7 depict to rows of staples, however, it is contemplated that any number of rows may be utilized. The cartridges 124 move laterally caused by user interaction. FIGS. 6 and 7 depict two rows of staples 143. The two rows of staples 143 are each maintained by the cartridge 124. The first row 161 and the second row 181 may be slid laterally under the driving member 108 for causing a staple to be driven into a material, such as a stack of paper. The driving member 108, upon the lever receiving a force, causes a staple be ejected from the stapler and more specifically to be ejected from the cartridge. In an embodiment, even though the staples share driving member 108, the staples may be ejected independently in the sense that they are ejected and/or driven without relation and/or independent to the other rows of staples. FIG. 6 depicts the first row 161 in position to be driven by driving member 108. FIG. 7 depicts the second row 181 in position to be driven by driving member 108. While FIGS. 6&7 depict two rows of staples, any number of two or more rows may be implemented within the spirit of the present invention.

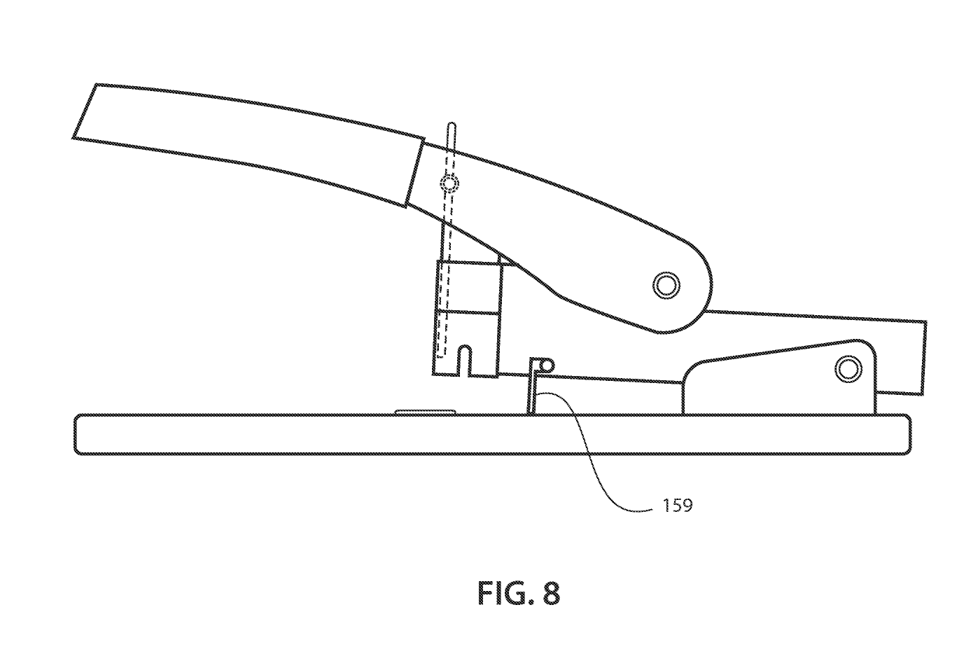

FIG. 8 shows an anti-jamming member 159 being moved into a vertical position. When the user operates the stapler by applying a downward force on lever 102, the cartridge will remain in the first position (or only move partially downward)—similar to FIG. 3—and the driving member will move into the third position—similar to FIG. 5. This may otherwise be defined as restraining the cartridge for preventing the cartridge from contacting the stapler plate. This will allow space for ejecting staples from the cartridge and/or otherwise un-jamming the stapler, as all too commonly, the staples simply cannot be ejected because the jammed staples are being pushed against the stapler plate. In an embodiment, the cartridge may be locked into place for allowing space for ejecting staples. Alternatively, an anti-jamming base member (not pictured) may be coupled to the base 130 wherein the anti-jamming base member may rise or be otherwise positioned to prevent the cartridge from moving fully downward, thus allowing space to eject a plurality of jammed staples. Commonly, staples become jammed because there is not enough room for the jammed staple(s) to exit the stapler. This aspect of the invention overcomes the shortcomings of the anti-jamming methods currently known.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A stapler comprising:
a base;
a cartridge in pivotal relation to the base at a cartridge pivot axis, the cartridge configured to contain at least two rows for maintaining staples; and
a lever arm in pivotal relation to the base at a lever pivot axis.

2. The stapler of claim 1 wherein the cartridge is configured to maintain a first row of first sized staples and wherein the cartridge is configured to maintain a second row of second sized staples.

3. The stapler of claim 1 further comprising:
a driver member coupled to the lever.

4. The stapler of claim 3 wherein the driver member is configured to move from a first position to a second position.

5. The stapler of claim 4 wherein the first position is positioned for driving a staple from a first row of the at least two rows of staples.

6. The stapler of claim 4 wherein the second position is positioned for driving a staple from a second row of the at least two rows of staples.

7. The stapler of claim 3 wherein the driver member moves a distance in relation to the lever.

8. A stapler comprising:
a base;
a lever arm coupled to the base; and
a cartridge coupled to the base, the cartridge operable to oscillate between at least a first position and a second position, the cartridge capable of simultaneously containing at least a first row of a first size of staples and a second row of a second size of staples.

9. The stapler of claim 8 further comprising a driving member for ejecting the staples from the cartridge.

10. The stapler of claim 9 wherein the stapler is configured to independently eject staples from the first and second row of staples.

11. The stapler of claim 8 further comprising an anti-jamming member coupled with the cartridge configured to restrain cartridge oscillation.

12. The stapler of claim 8 further comprising an anti-jamming member coupled with the cartridge configured to restrain cartridge movement.

13. The stapler of claim 12 wherein the anti-jamming member configured to move into a position for contacting the base for preventing downward movement of the cartridge.

14. A stapler comprising:
a body capable of maintaining at least two rows of staples.

15. The stapler of claim 14 further comprising a driving member configured for driving a staple from either of the at least two rows of staples.

16. The stapler of claim 15 wherein the body slides to position the driving member in driving relation to one of the at least two rows of staples.

17. The stapler of claim 15 wherein the driving member slides to position the driving member in driving relation to one of the at least two rows of staples.

18. The stapler of claim 14 wherein the stapler is capable of selectively driving a staple from either of the at least two rows of staples.

19. The stapler of claim 14 wherein the stapler is capable of independently driving a staple from either of the at least two rows of staples.

20. The stapler of claim 15 further comprising an anti-jamming member configured to permit the driving member to independently eject jammed staples from the cartridge.
